(19) United States
(12) Patent Application Publication
(10) Pub. No.: US 2007/0142023 A1
(43) Pub. Date: Jun. 21, 2007

(54) Telephone having power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD, Taipei City (TW)

(21) Appl. No.: 11/634,179

(22) Filed: Dec. 6, 2006

(30) Foreign Application Priority Data
Dec. 15, 2005 (CN) 200520144818.7

(51) Int. Cl. H04M 9/00

(52) U.S. Cl. 455/402

(57) ABSTRACT

The present invention provides a telephone capable of a communication through power line.

### FIELD OF THE INVENTION

The present invention relates to a telephone; more particularly, relates to a communication through a power line with an electricity having power frequency carrier integrated and modulated by a communication device.

### DESCRIPTION OF THE RELATED ART

A general telephone 2 (as shown in FIG. 7) comprises a processing unit 71 for audio signals, an audio T/R (transferring/receiving) unit 72 connected with the processing unit 71 to transfer the audio signals, and a man-machine interface unit 73 to dial number and operate required functions. The processing unit 71 is connected with a communication signal transmission line 8; and, the communication signal transmission line 8 is connected with a communication plug 9. Thus, an audio signal transference is obtained by using the telephone 7.

A general telephone can transfer audio signals. Yet, the telephone 7 must connect to a communication plug 9 with the communication signal transmission line 8; the communication plug 9 in a general house is usually located on a predefined position of a wall; and, there are usually only one or two communication plugs 9 set at the predefined position on a wall. So, the telephone can only be set near the predefined position which can not be easily changed to meet an actual need. Besides, when the user wants to add more telephones, usually a wire-extension box and an additional wire are required, which creates inconvenience on usage. Hence, the prior art does not fulfill users' requests on actual use.

### SUMMARY OF THE INVENTION

The main purpose of the present invention is to integrate an outside or indoor electricity with a communication signal by a first communication device and, after a modulation with power frequency carrier, to be transferred to a second communication device to obtain a communication using a telephone set.

To achieve the above purpose, the present invention is a telephone having power frequency carrier, comprising a first communication device and a telephone set, where the first communication device using power frequency carrier is connected with an input power line, a communication line and an output power line; an outside or indoor electricity from the input power line and a communication signal from the communication line are integrated and modulated to be outputted by the output power line; the telephone set comprises a processing unit, an audio T/R unit, a man-machine interface unit and a second communication device using power frequency carrier; and the second communication device is connected with the output power line. Accordingly, a novel telephone having power frequency carrier is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a view showing a preferred embodiment according to the present invention;

FIG. 2 is a view showing a first communication device for receiving signals according to the preferred embodiment of the present invention;

FIG. 3 is a view showing a second communication device for transferring signals according to the preferred embodiment of the present invention;

FIG. 4 is a view showing a first state of use according to the preferred embodiment of the present invention;

FIG. 5 is a view showing a second state of use according to the preferred embodiment of the present invention;

FIG. 6 is a view showing a third state of use according to the preferred embodiment of the present invention; and

FIG. 7 is a structural view of a prior art using power frequency carrier.

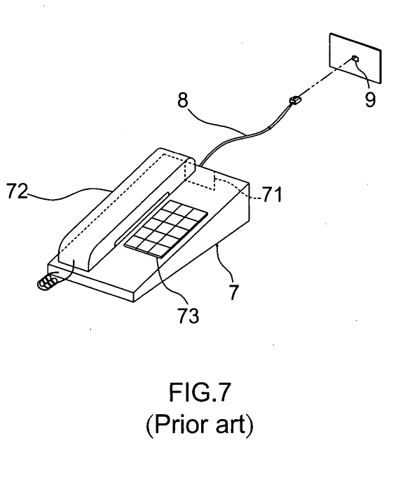

### DESCRIPTION OF THE PREFERRED EMBODIMENT

The following description of the preferred embodiment is provided to understand the features and the structures of the present invention.

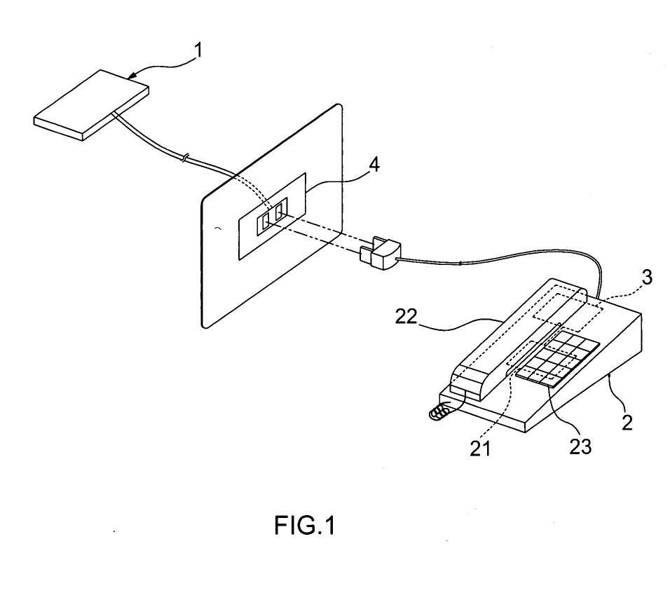

Please refer to FIG. 1, which is a view showing a preferred embodiment according to the present invention. As shown in the figure, the present invention is a telephone having power frequency carrier, comprising a first communication device 1 using power frequency carrier, a telephone set 2 and a second communication device 3 using power frequency carrier. Therein, the telephone set 2 comprises a processing unit 21 connecting to the second communication device 3, an audio T/R (transferring/receiving) unit 22 connecting to the processing unit 21, and a man-machine interface unit 23 connecting to the processing unit 21. The second communication device 3 is connected to an output power line 13 with a power lead line 36. The output power line 13 is connected to a plug module 4 located indoors. Consequently, the telephone set 2 obtains a communication over an indoor electricity having communication signal by using the second communication device 3.

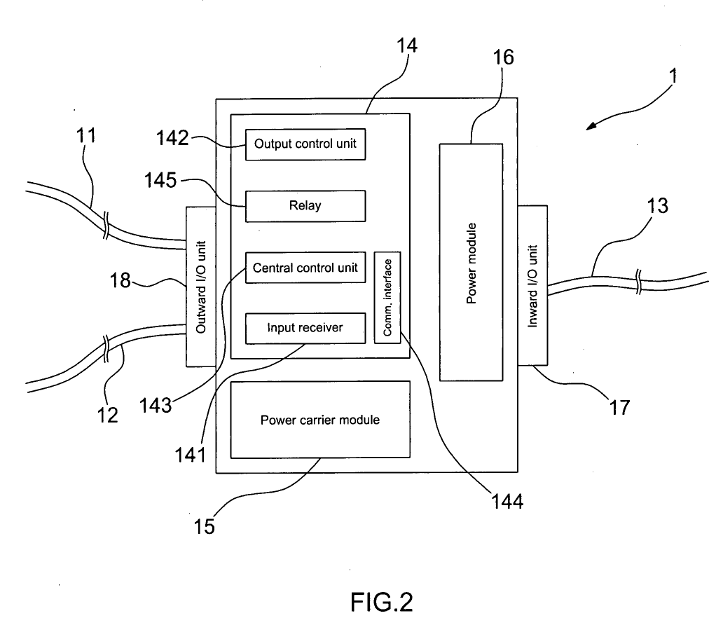

Please refer to FIG. 2, which is a view showing a first communication device for receiving signals according to the preferred embodiment of the present invention. As shown in the figure the first communication device 1 using power frequency carrier of the present invention comprises a single-chip control module 14, a power carrier module 15, a power module 16, an outward I/O (input/output unit 17 and an inward I/O unit 18. The first communication device 1 is connected with an input power line 11 to receive an outside electricity; a communication line 12 to receive a communication signal; and an output power line 13 to transfer an indoor electricity having the communication signal. The single-chip control module 14 comprises an input receiver 141, an output control unit 142, a control unit 143, a communication interface 144 and a relay 145. The data rate of the power carrier module 15 is 1200 BPS (bits per second); the control unit 143 is a 8051 single-chip whose working frequency is 16 MHz; and, the communication interface 144 is an RS232 interface. The first communication device 1 receives an outside electricity and a communication signal to be integrated to obtain an indoor electricity having the communication signal for a modulation, comprising the following procedure: the outside electricity from the input power line 11 and the communication signal from the communication line 12 are transferred through the inward I/O unit to the single-chip control module 14 and then to the power carrier module 15; the outside electricity and the communication signal are integrated to obtain an indoor electricity having the communication signal; and, the indoor electricity is modulated to be transferred to the output power line 13.

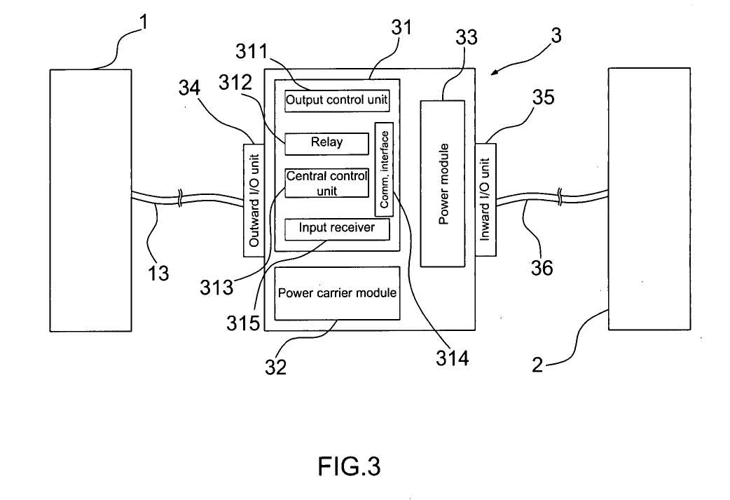

Please refer to FIG. 3, which is a view showing a second communication device for transferring signals according to the preferred embodiment of the present invention. As shown in the figure, a second communication device 3 comprises a single-chip control module 31; a power carrier module 32 with a data rate of 1200 BPS; a power module 33 to provide required power for the single-chip control module 31 and the power carrier module 32; an outward I/O unit 34; and an inward I/O unit 35. Therein, the single-chip control module 31 comprises an output control unit 311, a relay 312, a central control unit 313, a communication interface 314 and an input receiver 315. The central control unit 313 is a 8051 single-chip as a processing unit with a good inner structure, whose working frequency is up to 16 MHz together with a 4 k size of electrically programmable and erasable ROM (Read Only Memory) together with eight input pins and eight output pins. The relay 312 is located at the output pins to quarantine the circuit for securing and ensuring the operation of the 8051 single-chip. The 8051 single-chip contains a full-duplex communication interface 314 inside. The communication interface 314 is an RS232 interface to simultaneously transfer and receive data from outside. The operational signals are on a TTL (transistor-transistor-logic) level (0 voltage set as logic 0; +5 voltage set as logic 1) and the communication interface 314 is a serial communication interface to transfer or receive data in a form of series of bits.

After the first communication device 1 integrates an outside electricity and a communication signal to obtain an indoor electricity having communication signal together with that the indoor electricity is modulated, the indoor electricity is received by the outward I/O unit 34 of the second communication device 3 through a power line 13. A mode and a speed for a transmission are detected and setup by the single-chip control module 31. Then, a command from the single-chip control module 31 is transmitted to the inward I/O device 35 so that the indoor electricity having communication signal is modulated through the power carrier module 32 to obtain the communication signal to be transferred to the inward I/O unit 35 and is further transferred to the telephone set 2.

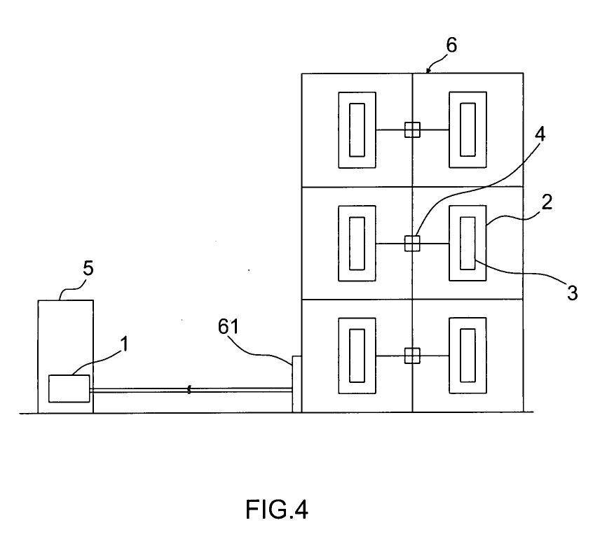

Please refer to FIG. 4 which is a view showing a first state of use according to the preferred embodiment of the present invention. As shown in the figure, a first communication device 1 is located at a electrical and communication provider 5 to integrate an outdoor electricity and a communication signal to obtain an indoor electricity having the communication signal. The first communication device 1 transfers the indoor electricity to an electrical and communication control room 61 of a building 6 after the indoor electricity is modulated, where the householders in the building can plug a telephone set 2 to a plug module 4 located indoors so that a communication is obtained between the first communication device 1 and the telephone set 2 through a second communication device 3.

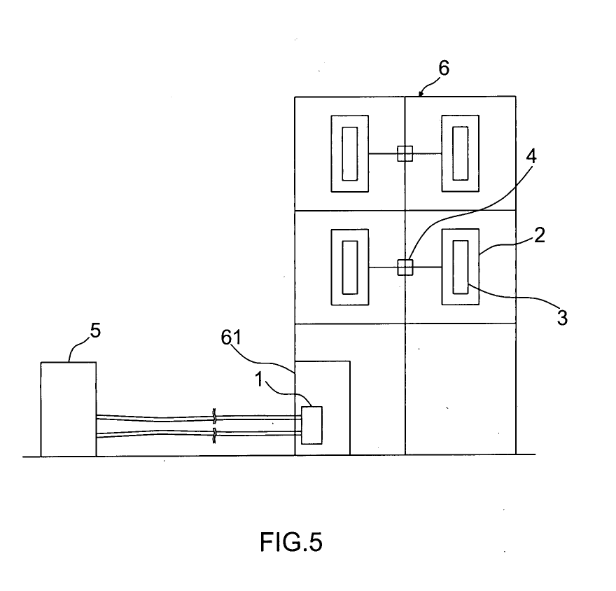

Please refer to FIG. 5, which is a view showing a second state of use according to the preferred embodiment of the present invention. As shown in the figure, a first communication device 1 is located in an electrical and communication control room 61 of a building 6 to receive an outdoor electricity and a communication signal from an electrical and communication provider 5 to be integrated for obtaining an indoor electricity having the communication signal. After the indoor electricity is modulated in the first communication device 1 and is transferred out, the householders in the building 6 can plug a telephone set 2 to a plug module 4 located indoors so that a communication is obtained between the first communication device 1 and the telephone set 2 through a second communication device 3.

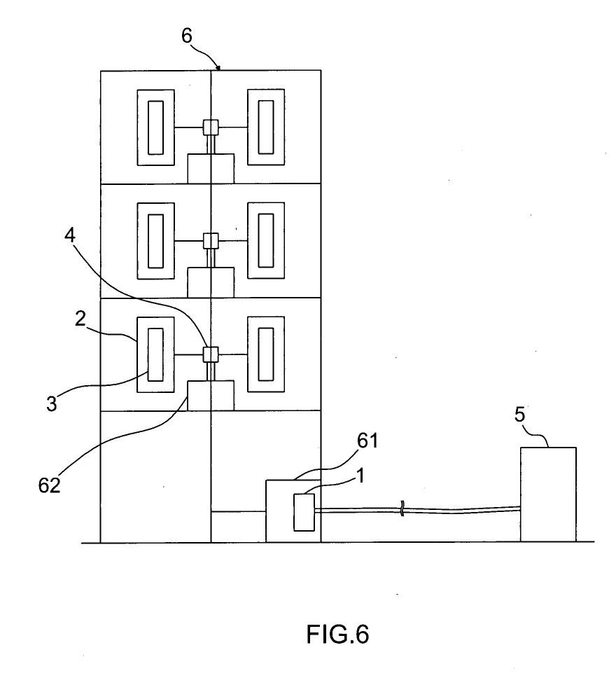

Please refer to FIG. 6, which is a view showing a third state of use according to the preferred embodiment of the present invention. As shown in the figure, a first communication device 1 is located in a distribution box 62 of a building 6 to receive an outdoor electricity and an communication signal from the distribution box 62 for an integration to obtain an indoor electricity having the communication signal, where the outdoor electricity and the communication signal for the distribution box 62 are obtained from an electrical and communication provider 5. After the indoor electricity is modulated in the first communication device 1 and is transferred out, the householders in the building can plug a telephone set 2 to a plug module 4 located indoors so that a communication is obtained between the first communication device 1 and the telephone set 2 through a second communication device 3.

To sum up, the present invention is a telephone having power frequency carrier, which utilizes a first and a second communication devices using power frequency carrier, while coordinated with a telephone set, to integrate an outside electricity and a communication signal by the first communication device to be transferred to the second communication device to obtain a communication with the telephone set.

The preferred embodiment(s) herein disclosed is/are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A telephone having power frequency carrier, comprising:
(a) a first communication device using power frequency carrier, said first communication device connecting to an input power line to receive an outside electricity, said first communication device connecting to a communication line to receive a communication signal, said first communication device connecting to an output power line to transfer an indoor electricity, said indoor electricity obtained by integrating said outside electricity and said communication signal; and
(b) at least one telephone set, said telephone set comprising a processing unit, an audio T/R (transferring/receiving) unit, a man-machine interface unit and a second communication device, said audio T/R unit connecting to said processing unit, said man-machine interface unit connecting to said processing unit, said second communication device using power frequency carrier, said second communication device connecting to said processing unit, said second communication device connecting to said output power line.

2. The telephone according to claim 1,
wherein said first communication device is located at an electrical and communication provider to integrate said outdoor electricity and said communication signal to obtain said indoor electricity having said communication signal and
wherein said first communication device transfers said indoor electricity to said telephone set after said indoor electricity is modulated.

3. The telephone according to claim 1,
wherein said first communication device is located in an electrical and communication control room of a building to integrate said outdoor electricity and said communication signal to obtain said indoor electricity having said communication signal; and
wherein said first communication device transfers said indoor electricity to said telephone set after said indoor electricity is modulated.

4. The telephone according to claim 1,
wherein said first communication device is located in a distribution box of a building to integrate said outdoor electricity and said communication signal to obtain said indoor electricity having said communication signal; and
wherein said first communication device transfers said indoor electricity to said telephone set after said indoor electricity is modulated.

5. The telephone according to claim 1, wherein each of said first and said second communication devices comprises a single-chip control module, a power carrier module, a power module, an outward I/O (input/output) unit and an inward I/O unit.

6. The telephone according to claim 5, wherein said single-chip control module comprises an input receiver, an output control unit, a central control unit, a communication interface and a relay.

7. The telephone according to claim 5, wherein said power carrier module comprises a data rate of 1200 BPS (bits per second).

8. The telephone according to claim 6, wherein said control unit is a 8051 single-chip.

9. The telephone according to claim 5, wherein said central control unit comprises a working frequency of 16 MHz (megahertz).

10. The telephone according to claim 5, wherein said communication interface is an RS232 interface.
